(19) United States
(12) Patent Application Publication
(10) Pub. No.: US 2016/0358506 A1
(43) Pub. Date: Dec. 8, 2016

(54) COMPUTERIZED SYSTEM AND METHOD FOR TRACKING CHILDRENS HEALTH ACTIVITIES

(71) Applicant: Jeannette Bahouth, Louisville, KY (US)

(72) Inventor: Jeannette Bahouth, Louisville, KY (US)

(73) Assignee: HUMANA INC., Louisville, KY (US)

(21) Appl. No.: 13/368,768

(22) Filed: Feb. 8, 2012

(51) Int. Cl. G09B 19/00

(52) U.S. Cl. CPC G09B 19/0092

(57) ABSTRACT

A computerized system and method to assist young children in tracking and learning about their eating and exercise habits is disclosed. The computerized system and method integrates a pedometer device, a “kid-friendly” website, and a secured server that provides data collection points, a personal health information (PHI) secured data repository, and a reporting/analysis component for food and activity metrics. Health and wellness related data enter by participants via the website includes individual details of food choices, activities, and attitudes towards health and wellness. The computerized system and method may be used as a measurement tool to monitor student health and encourage students to be more aware of their daily choices regarding food and exercise.

### CROSS-REFERENCE TO RELATED APPLICATIONS

None.

### BACKGROUND OF THE INVENTION

As school-aged children grow older, they take a more active role in what they eat. Whether at school, home, or elsewhere, they have numerous options for every meal or snack, not all of which are healthy. As they, and not their parents or guardians, make more and more decisions about what to eat, they develop eating habits over time that may not be healthy. If their eating habits are unhealthy too frequently or for too long, they may become overweight or obese or they may develop one of many health complications that result from unhealthy eating. Unhealthy eating habits, like many bad habits, are difficult to break. Therefore, it is important for young children that are taking a more active role in their eating decisions to learn to make healthy choices.

Getting school-aged children, especially younger children, to make healthy choices can be difficult. Young children first need to learn which foods are healthy and which are not. Even if children know the difference, there are other factors that may influence their decisions. Like many adults, they may have limited time for meals and snacks because of school workloads or extra-curricular activities. As a result, they may choose “fast” options that are not necessarily healthy options. If they are really busy, they may not even realize what choices they are making and how often they are making unhealthy choices. In other instances, they may simply be too tempted by unhealthy options that they believe taste better than healthy alternatives. In either case, they may not be able to change their eating habits without assistance.

Health problems that some children face today are impacted by more than their eating habits. For many school-aged children, computer and video games as well as other sedentary activities such as watching movies and television have surpassed playing outdoors or even indoors as the preferred pastime. Playgrounds and play equipment designed for elementary school children that provide entertainment as well as an opportunity for physical activity sometimes are of less interest than technology-based pastimes. As interest in playgrounds and play equipment as well as opportunities for active play decreases, fewer and fewer children are getting the exercise they need to attain and maintain a healthy weight and lifestyle. As the number of gaming and viewing options for younger children increases and they become more involved in making their own choices, the problems associated with a sedentary lifestyle impact their health. As with their eating habits, they may not understand the implications of their choices or they may not realize how frequently they are choosing sedentary activities over physical activities. As with eating, it may be difficult for them to change their physical activity habits without assistance.

There are many school-aged children that would benefit from changes and improvements to their eating and exercise habits. Before changing or improving their habits, however, they need to learn what they are. Although computerized systems and methods for tracking eating and exercising are known, they are typically directed toward adults. They are designed and developed for use by adults and therefore, have user interfaces that most children, especially young children, would have a difficult time using. There is a need for a computerized system and method to assist young children in tracking and learning about their eating and exercise habits. There is a need for a computerized system and method that is easy for young children to use and that assists young children in learning and understanding good eating and exercise habits. There is a need for a computerized system and method that further promotes good eating and exercise habits by allowing children to see changes and improvements to their eating and exercise habits. There is a need for a computerized system and method that supports review and analysis of eating and exercise data for children, aggregation and integration of data for multiple children, and comparisons of data for children as well as adults.

### SUMMARY OF THE INVENTION

A computerized system and method is disclosed that: 1) assists young children in tracking and learning about their eating and exercise habits; and 2) provides administrative functions and summary reports to support a school in the review and analysis of eating and exercise data for individual children, aggregation and integration of data for multiple children, and comparisons of data for children as well as adults. The computerized system and method is easy for young children to use and assists young children in learning and understanding good eating and exercise habits. It further promotes good eating and exercise habits by allowing children and school administrators to record data and view changes, and more importantly, improvements to their habits.

The computerized system and method may be used by students, parents, guardians, teachers, and program administrators of schools and other organizations that would like to offer and support initiatives in health and wellness. In an example embodiment, the computerized system and method integrates a pedometer device, a “kid-friendly” website, a secured server that provides data collection points, a personal health information (PHI) secured data repository that meets all Family Educational Rights and Privacy Act (FERPA) requirements, a reporting/analysis component for activity metrics collected from pedometers, and health and wellness related data entered by the program participants via the website that includes individual details of food choices, activities, and attitudes towards health and wellness.

The computerized system and method may be used as a measurement tool that schools can use to monitor student health and encourage students to be more aware of their daily choices regarding food and exercise. Any organization that would like to promote good health habits and wellness to children may use the computerized system and method. In an example embodiment, the website of the computerized system and method comprises a “diary page” for students, teachers, and parents/guardians to record their nutrition choices and physical activities. The interface is designed for ease of use by children so they can record their own data rather than rely on adults to do it for them. The website also has a “report card” page that shows students' choices over time, offers health tips, and gives students a chance to participate in a pedometer step or other physical challenge. Other features support comparisons and aggregation of data for multiple children and well as participating adults.

### BRIEF DESCRIPTION OF THE DRAWINGS

FIG. 1 is an example diary page according to an example embodiment;

FIG. 2 is an example profile page according to an example embodiment;

FIG. 3A is an example avatar selection page according to an example embodiment;

FIG. 3B is an updated profile page;

FIG. 3C is an example profile edit page according to an example embodiment;

FIGS. 4A and 4B are example diary pages according to an example embodiment;

FIGS. 5A and 5B are example food selection pages according to an example embodiment;

FIGS. 6A and 6B are example activity selection pages according to an example embodiment;

FIGS. 7A and 7B-C are example report card pages for an example embodiment; and

FIGS. 8A and 8B are a summary report card page according to an example embodiment.

### DETAILED DESCRIPTION

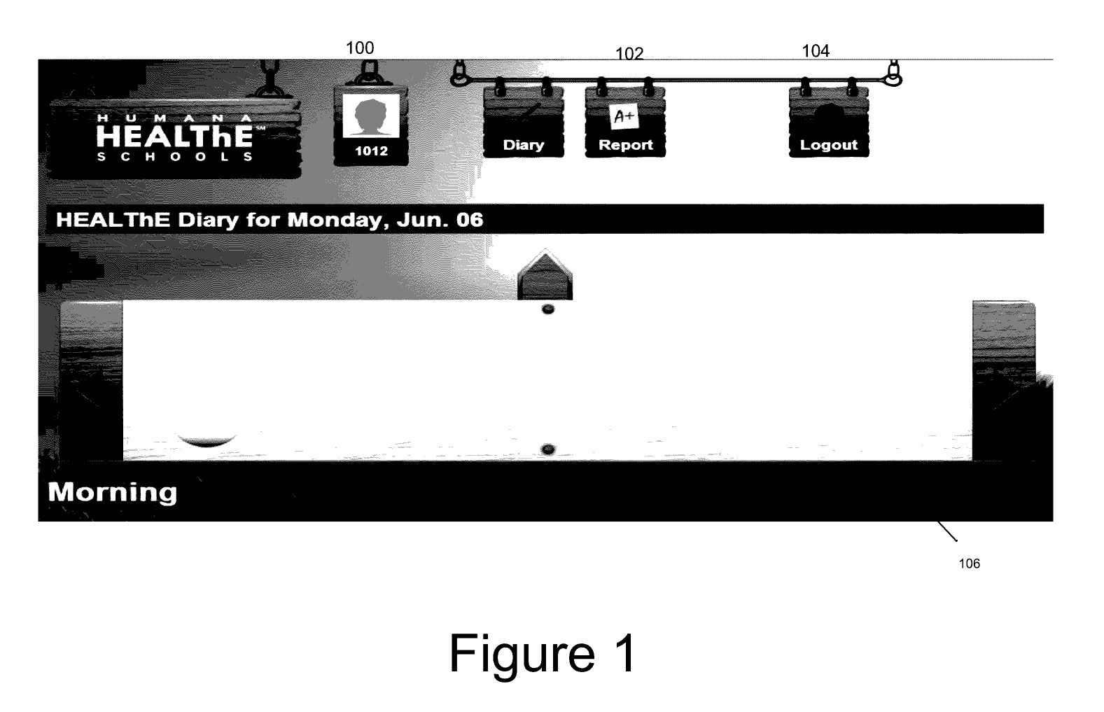

Referring to FIG. 1, an example diary page according to an example embodiment is shown. In an example embodiment, the diary page is the first page that appears after the participant logs in. From the diary page, the participant may select an option to navigate to a profile page 100, the food or activity diary pages, or a report page 102. The page may also have a logout option 104. In an example embodiment, the diary page may be used record a participant's personal decisions, choices, and activities. In an example embodiment, the page is used to record decisions that were made the previous day 106. Over time, the participant's decisions and choices regarding food and exercise reflect his or her habits and assist the participant or his or her parent/guardian in identifying areas for improvement.

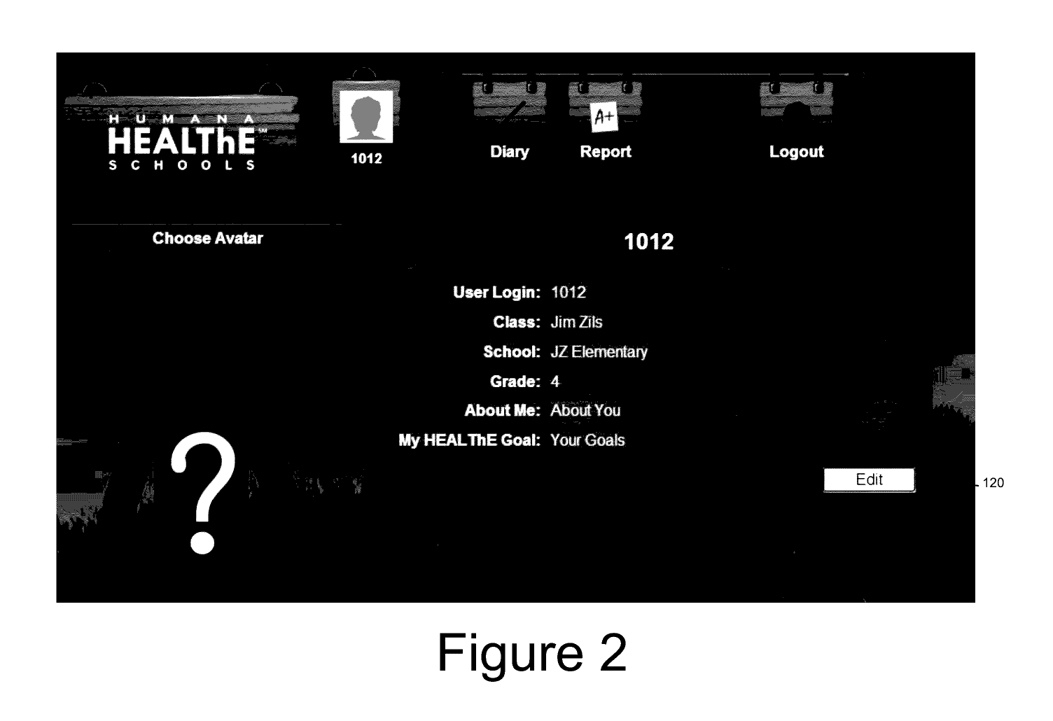

Referring to FIG. 2, an example profile page according to an example embodiment is shown. The page displays the participant's profile information and comprises an option for editing the profile 120.

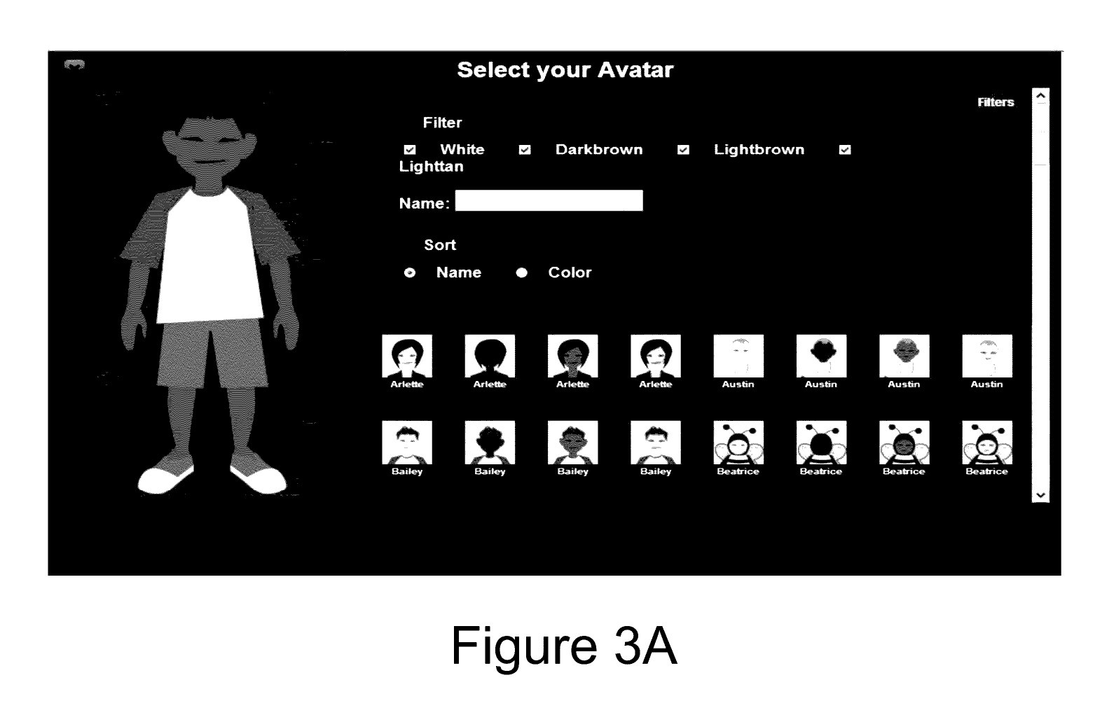

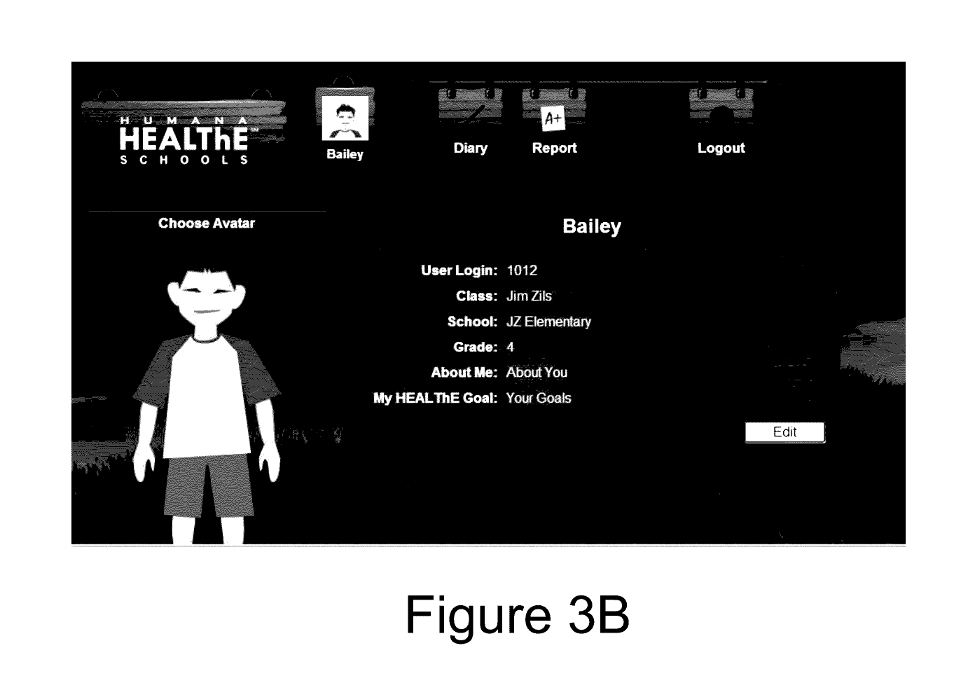

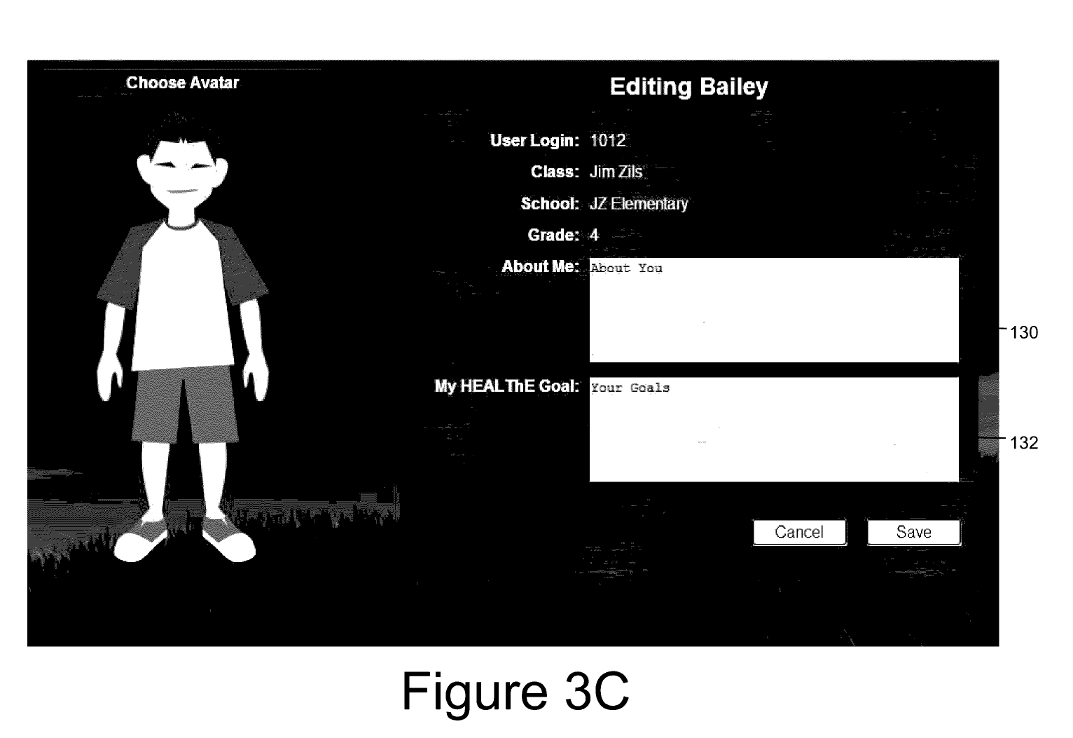

Referring to FIG. 3A, an example avatar selection page according to an example embodiment is shown. The page presents a variety of avatars from which a participant may select to represent the participant in other pages that are generated as the participant navigates the site and selects options involving the display of data related to the participant. The use of an avatar in connection with collecting and presenting information about healthy habits makes the site more interesting and engaging to a younger audience. As a result, young users may spend more time at the site and as a result, learn more about themselves as well as healthy eating and exercise habits. Referring to FIG. 3B, an updated profile page that reflects the participant's selection of an avatar is shown.

Referring to FIG. 3C, an example profile edit page according to an example embodiment is shown. The page comprises an “About Me” section 130 in which the participant can enter personal information and a “My HEALThE Goal” section 132 in which the participant can enter details about a personal health or wellness goal.

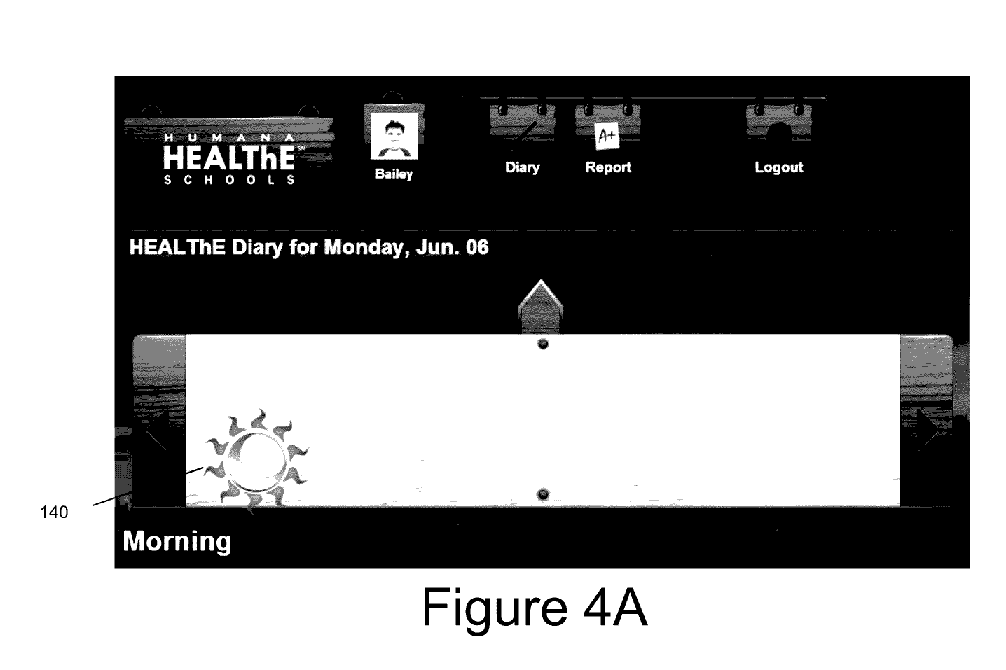

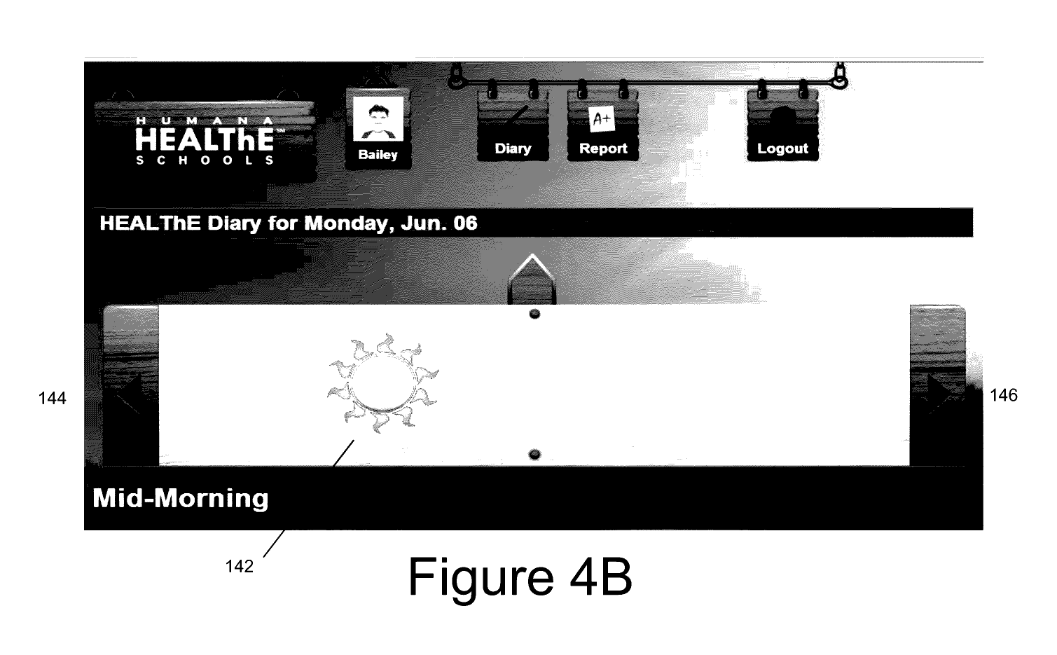

Referring to FIGS. 4A and 4B, example diary pages according to an example embodiment are shown. The diary page allows participants to enter food choices made the previous day. In an example embodiment, participants may enter food choices corresponding to five “time of day” selections. In an example embodiment, the “time of day” selections may correspond to meal times as depicted at the top of the page by the time at which that meal is eaten (sun/moon icon) and written in text above a checkered food tray. In an example embodiment, a default date is presented at the top of the page and the date is always the previous day's date. The presentation of a default date facilitates the entry of food choices and activities by younger children who may not yet understand calendars or may not remember the previous day's date.

Referring to FIG. 4A, the diary page comprises a section corresponding to a “morning” time period. Alternatively, the morning time period may be labeled “breakfast.” Additional diary pages may correspond to other time periods or meals throughout the day such as mid-morning snack, early afternoon or lunch, afternoon snack, and evening or dinner. The page may further comprise an icon positioned in a manner to indicate the applicable time period or meal. In the example shown, the page comprises a rising sun icon near the bottom of the page 140 to indicate the time period is morning or breakfast-time. In subsequent diary pages, a different icon may appear in a different location to indicate a different time of day.

Referring to FIG. 4B, an example “mid-morning” page with a full sun icon 142 in a new position is shown. To move between “time of day,” meal, or time period selections, the participant may interact with the arrow 144, 146 on either side of the post. Alternatively, the page may comprise text at the bottom of the page indicating the meal for which they may enter data on the next page. The use of time periods rather than specific times as well as icons representative of the time period facilitates the recording of dietary information by younger children who may not yet know how to tell time or are unlikely to know or remember exactly when they ate a particular food. Text indicating the meal typically eaten during the time period (e.g., breakfast, lunch, dinner) may also facilitate recording of dietary information.

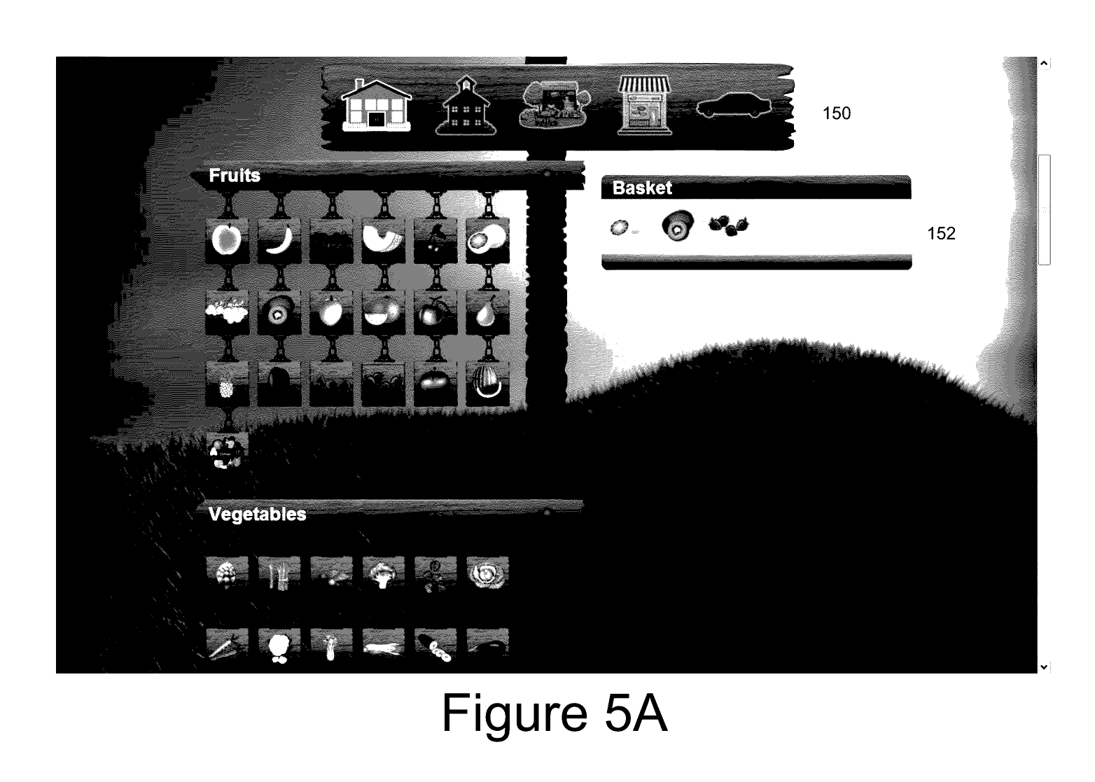

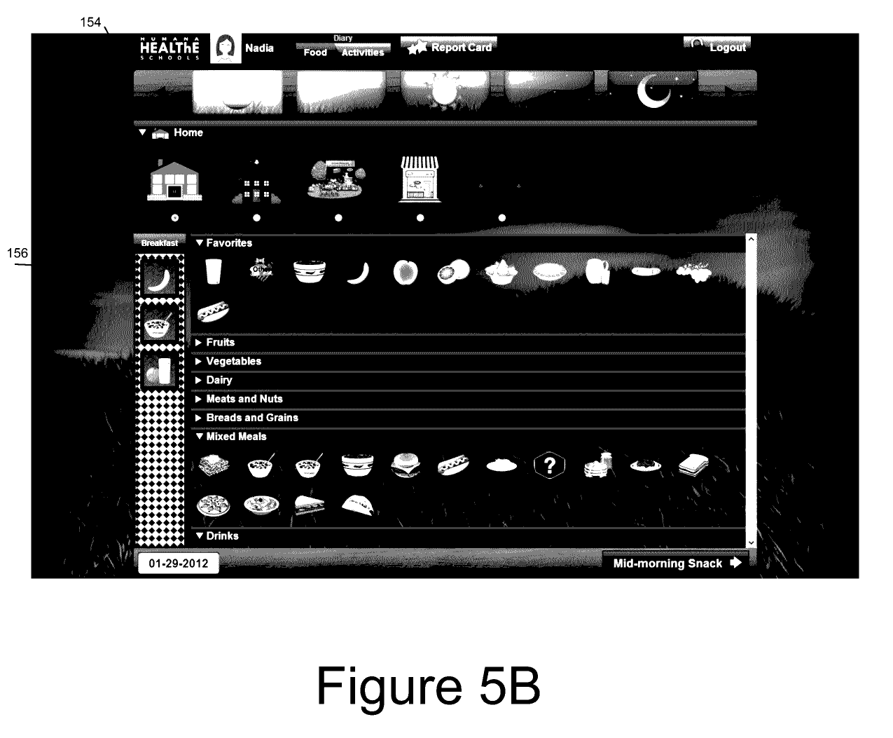

Referring to FIG. 5A, a first example food selection page according to an example embodiment is shown. The food selections correspond with a previously selected “time of day” or meal and default date of the previous day. Initially, the participant indicates where the meal or snack was eaten by selecting an icon 150 depicting a location where food is commonly consumed. In an example embodiment, the locations are: home; school; a sit-down restaurant; a fast food restaurant; or the car. To identify a food that was eaten, the participant selects a food icon from a category of foods. If the participant is unsure of the food represented in an icon, the participant may use the computer mouse to hover over the food icons which cause the name of the food to appear. The selected food appears in a basket 152. The participant may make as many selections as needed to indicate what he or she ate. A food item may be “de-selected” by clicking on the item in the basket 152. Additional categories of foods and food items may be accessed by scrolling down the page.

Referring to FIG. 5B, a second example food selection page is shown. The applicable “time of day” or meal options may be displayed at the top of the page with the selected time highlighted 154. The participant may select a location and a category of food and then select a specific food item. Selected foods appear in a checkered tray which also indicates the applicable time of day or meal 156. Additional categories of foods and food items may be accessed by selecting the name of the food category which may include a “mixed meals” category.

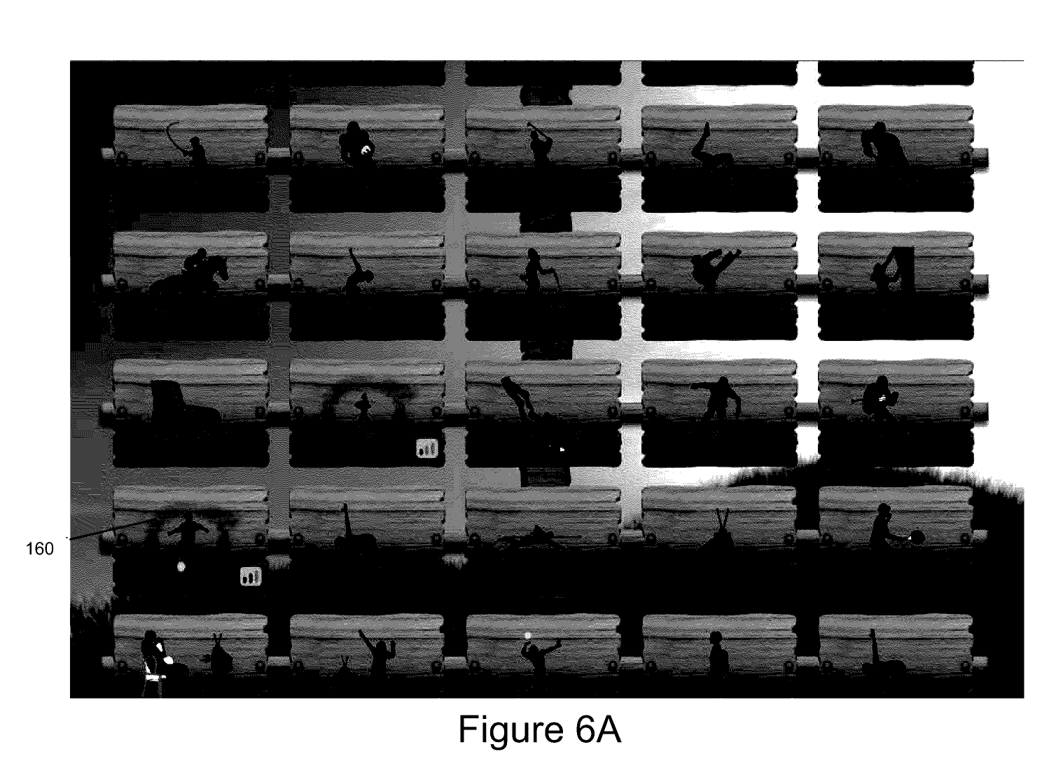

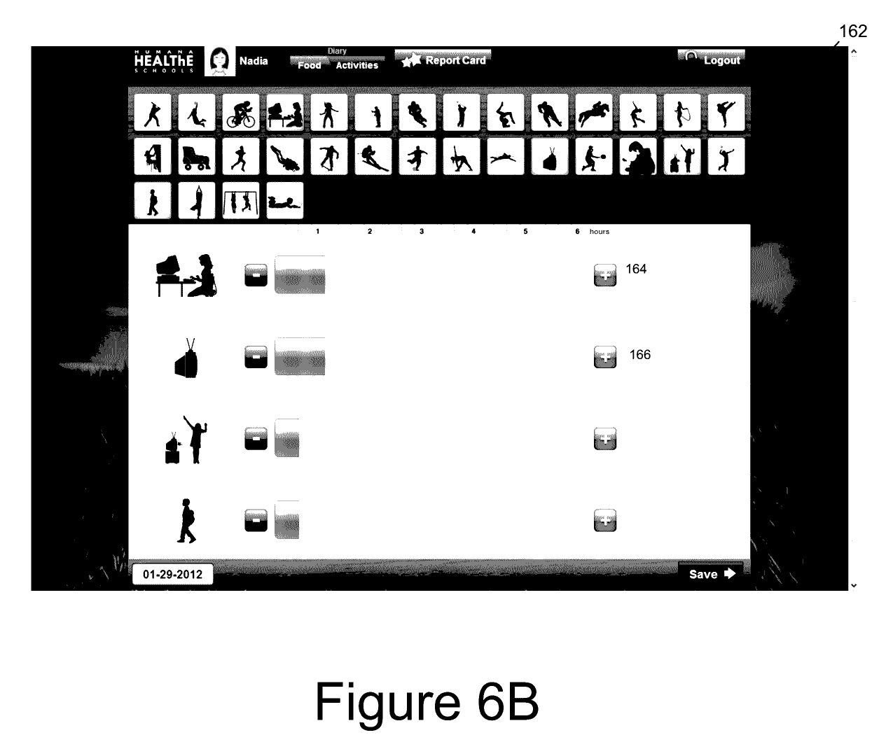

Referring to FIG. 6A, a first example activity selection page according to an example embodiment is shown. Activities are displayed as a series of icons depicting different activities such as fishing, basketball, golf, etc. In an example embodiment, a participant may use the computer mouse to hover over activity icons which causes the name of the activity to appear. The participant then may select an icon to select an activity in which the participant engaged the previous day 160. The participant may further indicate the level or intensity of the activity by selecting an activity icon multiple times. The participant may select an activity icon once to show a small amount of activity. The icon decreases in size and a legend in the lower right corner of the selected activity icon indicates a single bar representing the smallest amount of time (e.g., about 30 minutes). Selecting the activity icon a second time causes the activity icon to increase in size and the addition of a bar to the legend. The legend shows two bars representing a medium amount of time (e.g., 1 hour). A third click on the activity icon results in the addition of a third bar to the legend representing the largest amount of time (e.g., two or more hours). Additional activity icons may be accessed by scrolling to the bottom of the page. To complete the recording of activities for the day, the participant may select a “save” option.

Referring to FIG. 6B, a second example activity selection page is shown. Each selected activity icon 164, 166 appears below a list of activities 162 alongside a bar with an addition and a subtraction sign to either side. The participant may further indicate the time spent engaged in that activity by selecting the addition or subtraction sign to respectively add or subtract fifteen minutes. Every time the participant selects the addition sign, a bar fills in color by fifteen minute increments, indicated through a time metric above the bar. In an example embodiment, the time metric represents up to six hours. The participant may select the subtraction sign to remove time from the bar. To de-select an activity, the participant simply selects the icon of the activity. To complete the recording of activities for the day, the participant may select a “save” option.

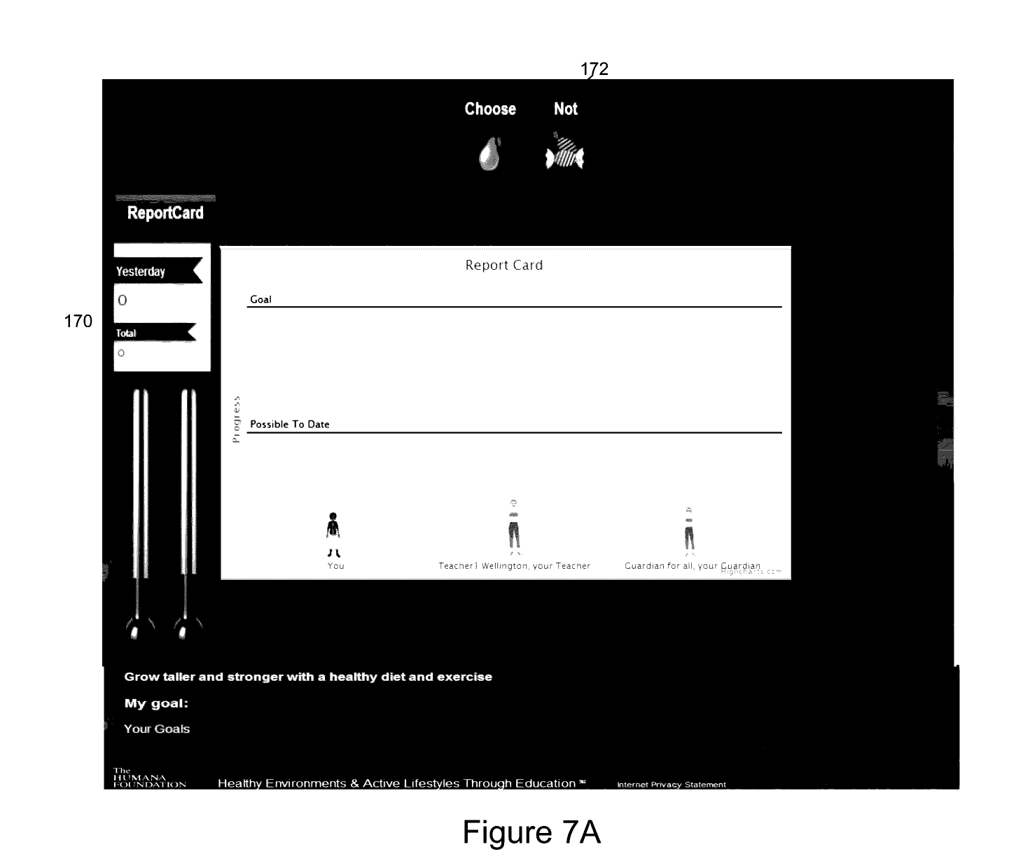

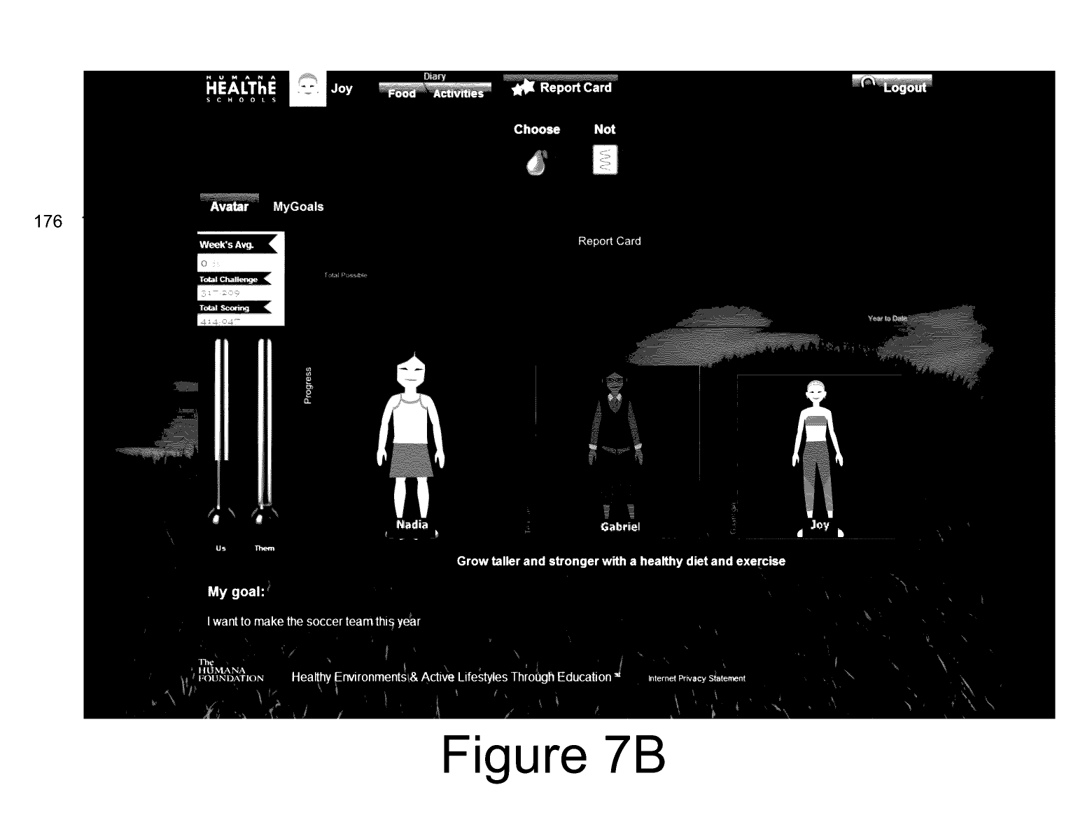

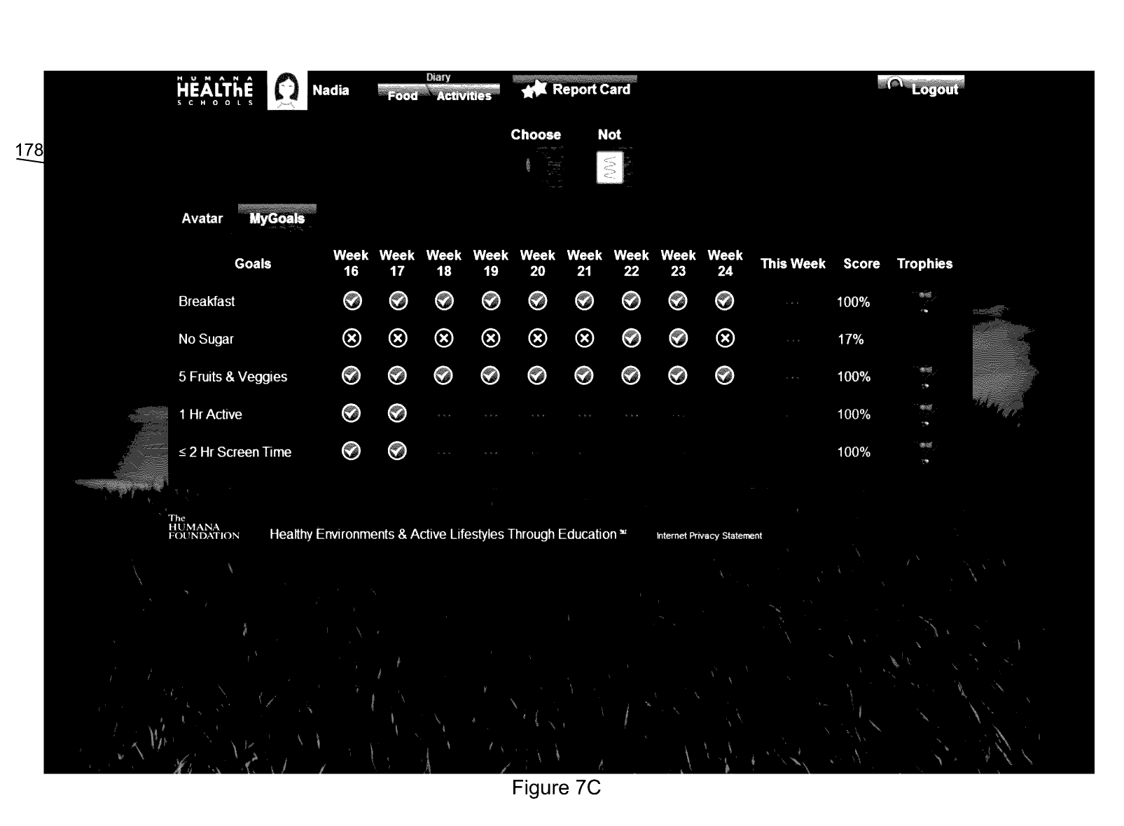

Referring to FIG. 7A, a first example report card page for an example embodiment is shown. In an example embodiment, the page may comprise thermometers 170 that track team progress in a pedometer step challenge. In an example embodiment, the page comprises a “health tip” section 172 for displaying information about making healthy food choices. The message may consist of a “Choose {healthy alternative}” icon and a “Not {undesirable food selection}” icon. The undesirable food selection relates to one made by the participant. The “Choose” icon suggests a healthy alternative. Finally, the report card may comprise data regarding the participant's progress as well as the progress of other participants 174.

Referring to FIGS. 7B and 7C, a second example report card page for an example embodiment is shown. In an example embodiment, an “avatar” tab 176 may comprise thermometers that track team progress in a pedometer step challenge. The “avatar” section shown in FIG. 7B displays the participant's avatar in a bar graph that illustrates the participant's score based on their food and activity selections in relation to a “total to date” score and a “total possible” score or goal for a time period (e.g., semester). The score is calculated according to the number of times the participant reaches daily food and activity goals. The participant's avatar graph is also displayed with a teacher's and a guardian's avatar graphs so the participant can see his or her progress in relation to others.

Referring to FIG. 7C, a “my goals” tab 178 displays the health goals for the participant's group. Participants may hover over the abbreviation for the goal to read the goal in full. In an example embodiment, current goals may include: 1) eat breakfast every day; 2) avoid sugary drinks and foods every day; 3) have five servings of non-starch fruits and vegetables every day; 4) get one hour of physical activity daily; 5) spend two hours or less in front of a screen each day. If the participant meets the goal in a given week, a green circle with a check mark inside it appears under the given week. If the participant did not meet the goal in a given week, a red circle with an “x” inside it is displayed. If the participant did not track information that week, ellipses appear instead of the circle icon. Weeks are numbered according to the “scoring period” dates set by a group administrator. The two columns to the far right indicate the percent of goal attainment for each goal and the corresponding trophy (bronze, silver, or gold) if warranted.

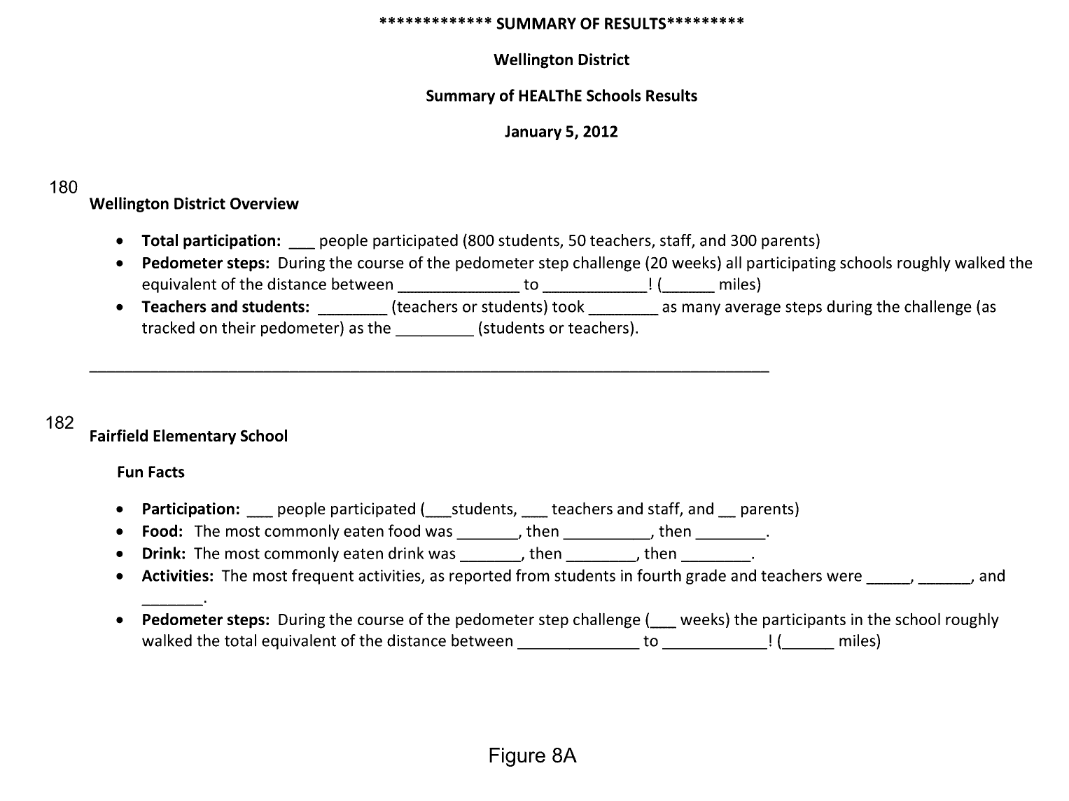

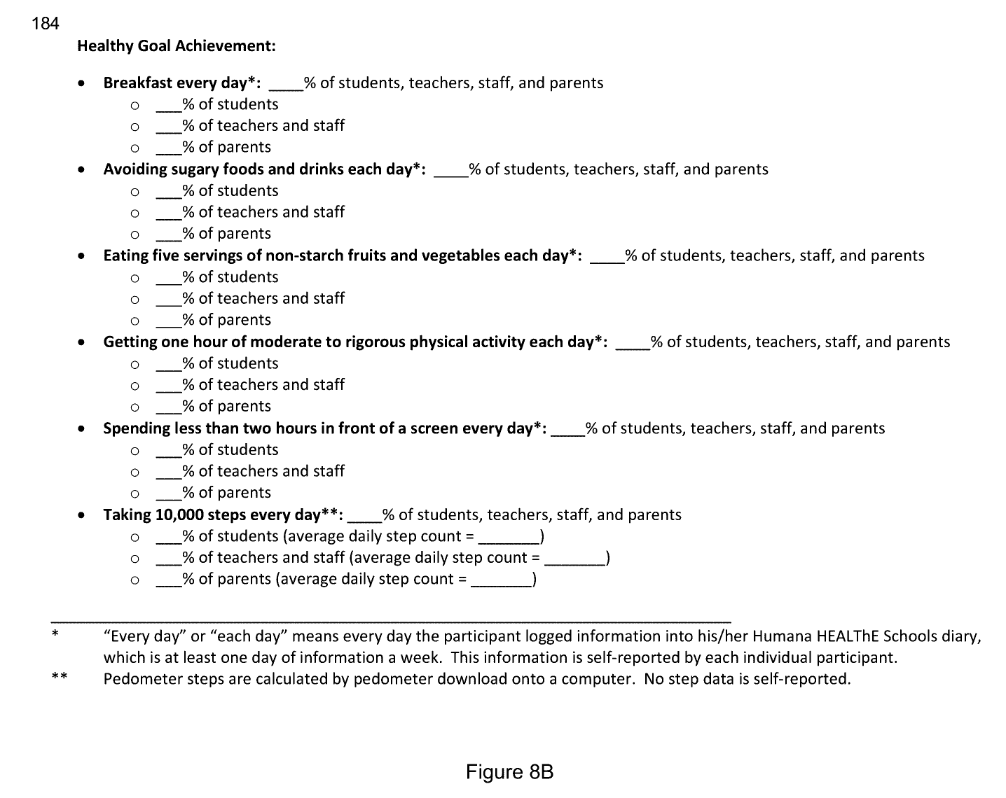

Referring to FIGS. 8A and 8B, an example summary report according to an example embodiment is shown. In an example embodiment, the summary of results report comprises a summary section for the school district administrator 180. The summary may comprise information about participation levels and related activity levels. The summary report page further comprises a section for reporting data for a specific school 182. The school summary section may comprise information about participation levels and observations related to the data that was collected. Finally, the summary report page may comprise a goals achievement section 184 summarizing progress toward various health related goals established at the beginning of the program. Administrator pages may further offer the ability to: 1) add users and user groups; 2) assign pedometers to users; 3) set scoring period dates; 4) set challenge dates and challenge groups; and 5) run summary reports. Users granted administrator access may have varying levels of permission to perform the above functions depending on the user's role within an organization or school district.

While certain embodiments of the present invention are described in detail above, the scope of the invention is not to be considered limited by such disclosure, and modifications are possible without departing from the spirit of the invention as evidenced by the claims. For example, elements of the user interface may be varied and fall within the scope of the claimed invention. Various aspects of data collection and presentation may be varied and fall within the scope of the claimed invention. One skilled in the art would recognize that such modifications are possible without departing from the scope of the claimed invention.

1. A computerized method for tracking children's health activities comprising:
(a) receiving at a server from each of a plurality of computer users:
(1) identifying data for recording data for a child;
(2) a selection of a time of day wherein:
(i) said time of day is depicted as an icon on a background image in a position corresponding to said time of day; and
(ii) said background image comprises selectable elements for changing said icon and said position on said background image to depict a different time of day;
(3) a selection of at least one icon depicting a food item from a computer screen comprising a plurality of icons depicting food items;
(4) a selection of at least one icon depicting an activity from a computer screen comprising a plurality of icons depicting activities;
(5) recording in a database with said identifying data for said child said selection of said time of day, said selection of said food item, and said selection of said activity;
(b) repeating step (a) for a plurality of days;
(c) generating at said server for display to at least one of said plurality of computer users at least one screen comprising:
(1) an aggregated measure of said food item selections for said plurality of computer users over said plurality of days; or
(2) an aggregated measure of said activity selections for said plurality of computer users over said plurality of days.

2. The computerized method of claim 1 wherein receiving a selection of said time of day comprises receiving a selection of a time of day selected from the group consisting of:
morning, mid-morning, afternoon, mid-afternoon, evening, and late evening.

3. The computerized method of claim 1 wherein receiving a selection of said time of day comprises receiving a selection of a meal time selected from the group consisting of:
breakfast, mid-morning snack, lunch, mid-afternoon snack, dinner, and evening snack.

4. The computerized method of claim 1 wherein said computer screen comprising a plurality of icons depicting food items comprises icons depicting food items organized by food category.

5. The computerized method of claim 1 wherein receiving a selection of an icon depicting an activity further comprises receiving a selection of an activity level.

6. The computerized method of claim 5 wherein said selection of an activity level is indicated by selecting an activity icon a plurality of times.

7. The computerized method of claim 5 wherein said selection of an activity level is indicated by receiving a selection of an activity duration.

8. The computerized method of claim 7 wherein said selection of an activity duration is indicated by selecting a time increment icon.

9. The computerized method of claim 1 wherein said aggregated measure of said activity selections comprises a percentage of children selecting activities in a specified activity level.

10. The computerized method of claim 1 wherein said aggregated measure of said food item selections comprises a percentage of children selecting foods items in a specified food category.

11. The computerized method of claim 1 wherein said aggregated measure of said food item selections comprises a percentage of children eating at a specified period of time.

12. The computerized method of claim 1 further comprising:
receiving at said server from each of said plurality of computer users a selection of an icon depicting a location for eating a selected food item; and
recording in said database with said identifying data for said child said selection of said location.

13. A computerized method for tracking a child's health activity comprising:
(a) receiving at a server from a computer user:
(1) identifying data for recording data for a child;
(2) a goal related to said child's eating habits;
(3) a selection a time of day wherein:
(i) a plurality of icons, each comprising a graphic corresponding to a time period, appearing on a background image; and
(ii) one of said plurality of icons is highlighted against said background image indicating said selection of said time of day;
(4) a selection of at least one icon depicting a food item from a computer screen comprising a plurality of icons depicting food items;
(5) recording in a database with said identifying data for said child said selection of said time of day and said selection of said food item;
(b) repeating step (a) for a plurality of days;
(c) calculating at said server an aggregated measure of said food item selections for said child over said plurality of days; and
(d) generating at said server for display to said computer user at least one screen comprising an indicator of said aggregated measure in relation to said goal.

14. The computerized method of claim 13 wherein receiving a selection of said time of day comprises receiving a selection of a time of day selected from the group consisting of:
morning, mid-morning, afternoon, mid-afternoon, evening, and late evening.

15. The computerized method of claim 13 wherein receiving a selection of said time of day comprises receiving a selection of a meal time selected from the group consisting of:
breakfast, mid-morning snack, lunch, mid-afternoon snack, dinner, and evening snack.

16. The computerized method of claim 10 wherein said computer screen comprising a plurality of icons depicting food items comprises icons depicting food items organized by food category.

17. A computerized method for tracking a child's health activity comprising:
(a) receiving at a server from a computer user:
(1) identifying data for recording data for a child;
(2) a goal related to said child's exercise habits;
(3) a selection of at least one icon depicting an activity from a computer screen comprising a plurality of icons depicting activities;
(4) a selection of an activity level for said activity;
(5) recording in a database with said identifying data for said child said selection of said activity and said selection of said activity level;
(b) repeating step (a) for a plurality of days;
(c) calculating at said server an aggregated measure of said activity selections for said child over said plurality of days; and
(d) generating at said server for display to said computer user at least one screen comprising:
(1) a first indicator of said aggregated measure in relation to said goal; and
(2) a second indicator of at least one other participant's progress toward said goal.

18. The computerized method of claim 17 wherein said selection of an activity level is indicated by selecting an activity icon a plurality of times.

19. The computerized method of claim 17 wherein said selection of an activity level comprises receiving a selection of an activity duration.

20. The computerized method of claim 19 wherein said selection of an activity duration is indicated by selecting a time increment icon.
